(19) United States
(12) Patent Application Publication
(10) Pub. No.: US 2026/0179418 A1
(43) Pub. Date: Jun. 25, 2026

(54) INFORMATION PROCESSING SYSTEM

(71) Applicant: Toyota Jidosha Kabushiki Kaisha, Toyota-Shi (JP)

(72) Inventors: Toru FURUSAWA, Yokohama-Shi (JP); Zhenqin Shi, Tokyo-to (JP); Chihiro Mihara, Tokyo-to (JP); Shintaro Fukushima, Tokyo-to (JP); Masayuki Okamoto, Nagoya-shi (JP); Kaito Funabiki, Tokyo-to (JP)

(73) Assignee: Toyota Jidosha Kabushiki Kaisha, Toyota-Shi (JP)

(21) Appl. No.: 19/399,817

(22) Filed: Nov. 25, 2025

(30) Foreign Application Priority Data
Dec. 19, 2024 (JP) 2024-224346

(51) Int. Cl. G07C 5/08; G06F 16/735; G06V 20/56; G06V 20/70

(52) U.S. Cl. CPC G07C 5/0866; G06F 16/735; G06V 20/56; G06V 20/70

(57) ABSTRACT

An information processing system includes, a storage configured to store a video captured by a camera mounted on a vehicle within the vehicle, a generator configured to generate a feature text indicating characteristics of a scene from an image frame contained in the video stored in the storage, a feature storage provided outside the vehicle and configured to store the feature text, a query acquirer configured to acquire a search query from a user outside the vehicle to search for the video stored in the storage, a searcher configured to search for the feature text matching the search query from the feature text stored in the feature storage, and an outputter configured to extract the video corresponding to the feature text matching the search query from the storage and output the video to the user.

### INCORPORATION BY REFERENCE

This application is based upon and claims the benefit of priority from Japanese Patent Application No. 2024-224346, filed on Dec. 19, 2024, the disclosure of which is incorporated herein in its entirety by reference.

### TECHNICAL FIELD

The present disclosure relates to technical fields of an information processing system.

### BACKGROUND ART

A known system of this type manages video captured by a vehicle. For example, Japanese Patent Application Publication No. 2024-111025 discloses that a technology transmits only data matching predetermined detection conditions (i.e., location information or motion conditions, etc.) determined in advance according to a purpose of using a data, from among video data captured by a vehicle, to a server.

### SUMMARY

By using Large Language Models (LLM), which are constructed by a large amount of data and deep learning techniques, it is possible to automatically generate text related to video. It is conceivable to manage video by using such text, but it is not easy to appropriately manage a huge amount of video data captured by a vehicle. For example, in the technique described in Patent Document 1, as mentioned above, only data that matches the detection condition is transmitted to the server, and therefore, it is difficult to utilize the data that is not transmitted to the server, and it cannot be said that the video is being appropriately managed.

This disclosure has been made in view of the above-mentioned problems, and an object thereof is to provide an information processing system capable of appropriately managing video captured by a vehicle while reducing cost.

An information processing system according to an example aspect of the present disclosure includes: a storage configured to store a video captured by a camera mounted on a vehicle within the vehicle; a generator configured to generate a feature text indicating characteristics of a scene from an image frame contained in the video stored in the storage; a feature storage provided outside the vehicle and configured to store the feature text; a query acquirer configured to acquire a search query from a user outside the vehicle to search for the video stored in the storage; a searcher configured to search for the feature text matching the search query from the feature text stored in the feature storage; and an outputter configured to extract the video corresponding to the feature text matching the search query from the storage and output the video to the user.

### BRIEF DESCRIPTION OF THE DRAWINGS

FIG. 1 is a block diagram illustrating a hardware configuration of an information processing system according to an example embodiment.

FIG. 2 is a block diagram illustrating a functional configuration of the information processing system according to the example embodiment.

FIG. 3 is a flowchart illustrating a flow of a storage operation of the information processing system according to the example embodiment.

FIG. 4 is a flowchart illustrating a flow of an extraction operation of the information processing system according to the example embodiment.

### EXAMPLE EMBODIMENTS

Hereinafter, an information processing system according to an example embodiments will be described with reference to the drawings.

### Hardware Configuration

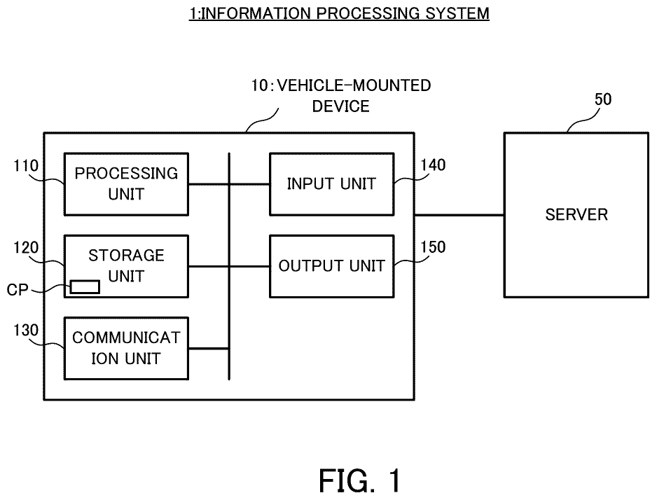

First, with reference to FIG. 1, a hardware configuration of the information processing system according to the example embodiment will be described. FIG. 1 is a block diagram illustrating the hardware configuration of the information processing system according to the example embodiment.

In FIG. 1, the information processing system 1 according to the example embodiment comprises a vehicle-mounted device 10 and a server 50. The vehicle-mounted device 10 is a device installed in a vehicle. On the other hand, the server 50 is a device installed outside the vehicle. The vehicle-mounted device 10 and the server 50 are configured to be capable of communicating via wireless communication. For convenience of explanation, a single vehicle-mounted device 10 and a single server 50 are shown here. However, multiple vehicle-mounted devices 10 may each be configured to communicate with a single server 50. Furthermore, a single vehicle-mounted device 10 may be configured to communicate with multiple servers 50. Additionally, multiple vehicle-mounted devices 10 may each be configured to communicate with multiple servers 50.

The vehicle-mounted device 10 is configured to include a processing unit 110, a storage unit 120, a communication unit 130, an input unit 140, and an output unit 150. The processing unit 110, the storage unit 120, the communication unit 130, the input unit 140, and the output unit 150 are interconnected via a data bus. All devices included in the vehicle-mounted device 10 described above may be mounted within the vehicle. However, some devices included in the vehicle-mounted device 10 may be mounted within the vehicle, while the remaining devices may be installed outside the vehicle.

The processing unit 110 is configured to execute various processing operations within the vehicle-mounted device 10. The processing unit 110 may include a processor. The processing unit 110 may have a single processor or may have multiple processors. That is, the processing unit 110 may have one or more processors. The processor may be a multi-core processor. If the processing unit 110 has a single processor that is a multi-core processor, the processing unit 110 can be said to logically have multiple processors.

The processors included in the processing unit 110 may be, for example, a CPU (Central Processing Unit), a GPU (Graphics Processing Unit), a FPGA (Field Programmable Gate Array), and a TPU (Tensor Processing Unit).

The storage unit 120 may be, for example, a RAM (Random Access Memory), a ROM (Read-Only Memory), a hard disk device, an optical magnetic disk device, an SSD (Solid State Drive), and an optical disk array. In other words, the storage unit 120 may be implemented by a single device or by multiple devices.

The storage unit 120 is capable of storing desired data. The storage unit 120 may store a computer program CP executed by the processing unit 110. The storage unit 120 may temporarily store data used by the processing unit 110 when the processing unit 110 is executing the computer program CP.

Furthermore, the computer program CP may be recorded on a recording medium that is readable by a computer and is not temporary. In this case, the computer program CP may be stored in the storage unit 120 by reading the recording medium using a recording medium reader (not shown) provided in the vehicle-mounted device 10. The recording medium may be at least one of optical discs, a magnetic medium, an opt magnetic disc, a semiconductor memory, and any other medium capable of storing a program. The computer program CP may be obtained from an external device (not shown) outside the vehicle-mounted device 10 via the communication unit 130. In other words, the computer program CP may be downloaded from an external device to the storage unit 120 of the vehicle-mounted device 10.

The processing unit 110 (e.g., a processor) may execute the processing to be performed by the vehicle-mounted device 10 together with the storage unit 120 (in other words, together with the storage unit 120 and the computer program CP stored in the storage unit 120). For example, by executing the computer program CP, the processing unit 110 may realize logical functional blocks within itself (e.g., within the processor) for performing the processing to be performed by the vehicle-mounted device 10.

The communication unit 130 is configured to communicate with devices external to the vehicle-mounted device 10. The communication unit 130 may perform wired communication or wireless communication.

The input unit 140 is a device capable of accepting information input to the vehicle-mounted device 10 from an external source. The input unit 140 may include an operating device operable by a user of the vehicle-mounted device 10 (e.g., a keyboard, a mouse, a touch panel, etc.). The input unit 140 may include a recording medium reading device capable of reading information recorded on a recording medium detachable from the vehicle-mounted device 10, such as a USB (Universal Serial Bus) memory. Furthermore, when information is input to the vehicle-mounted device 10 via the communication unit 130 (in other words, when the vehicle-mounted device 10 acquires information via the communication unit 130), the communication unit 130 may function as the input unit 140.

The output unit 150 is a device capable of outputting information to the external environment of the vehicle-mounted device 10. The output unit 150 may include a display device capable of outputting visual information such as characters or images as the aforementioned information. The output unit 150 may also include a speaker capable of outputting auditory information such as sound as the aforementioned information. The output unit 150 may be configured to output the aforementioned information (e.g., control information for other devices) to other devices. The output unit 150 may also be capable of outputting information to a removable storage medium, such as a USB memory, that can be attached to and detached from the vehicle-mounted device 10. Furthermore, when vehicle-mounted device 10 outputs information via the communication unit 130, the communication unit 130 may function as the output unit 150.

Server 50 may also have a hardware configuration similar to that of the aforementioned vehicle-mounted device 10. For example, the server 50 may be configured to include components similar to those of the processing unit 110, the storage unit 120, the communication unit 130, the input unit 140, and the output unit 150.

### <Functional Configuration>

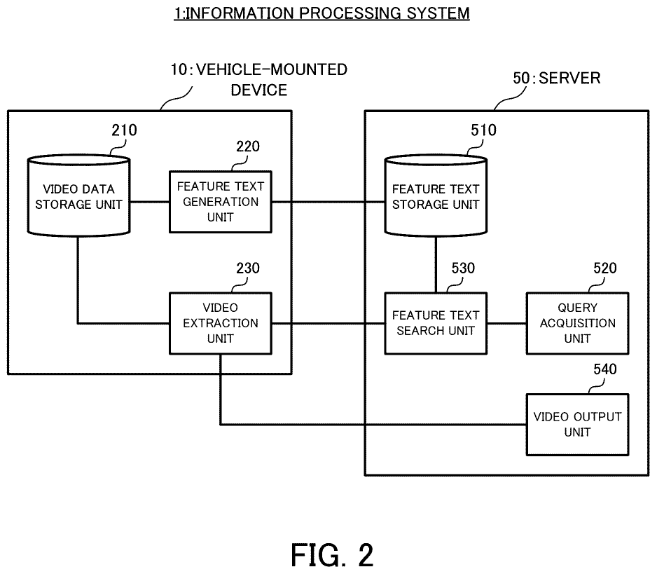

Next, with reference to FIG. 2, the functional configuration of the information processing system 1 according to the example embodiment will be described. FIG. 2 is a block diagram illustrating a functional configuration of the information processing system according to the example embodiment.

In FIG. 2, the information processing system 1 is configured as a system for managing video captured by the vehicle. The vehicle-mounted device 10 in the information processing system 1 includes, as components for realizing its functions, a video data storage unit 210, a feature text generation unit 220, and a video extraction unit 230. Furthermore, the server 50 in the information processing system 1 includes, as components for realizing its functions, a feature text storage unit 510, a query acquisition unit 520, a feature text search unit 530, and a video output unit 540. The feature text generation unit 220, the video extraction unit 230, the query acquisition unit 520, the feature text search unit 530, and the video output unit 540 may each be processing blocks implemented by the aforementioned processing unit 110. Furthermore, the video data storage unit 210 and the feature text storage unit 510 may each be databases implemented by the aforementioned storage unit 120.

The video data storage unit 210 is configured to store the video data captured by the vehicle. The video data typically includes data containing images of the vehicle's surroundings captured by a camera mounted on the vehicle, but may also include images of the vehicle's interior (i.e., the cabin). Furthermore, the video data storage unit 210 may be configured to acquire and store the video data captured by a terminal (e.g., a smartphone) owned by a user of the vehicle via wireless communication or similar means.

The video data storage unit 210 may have a function to delete video data with lower priority when storage capacity becomes low. This priority may be assigned based on at least one of information about the vehicle at the time the image was captured and information about the vehicle's surroundings. More specifically, images captured in situations with a low probability of occurrence may be assigned a higher priority (i.e., they may be less likely to be deleted).

The feature text generation unit 220 is configured to generate the feature text from the video data stored in the video data storage unit 210. Specifically, the feature text generation unit 220 analyzes each image frame contained in the video data to generate the feature text. The feature text is text data indicating the characteristics of the scene.

The feature text may include text corresponding to predetermined condition set in advance. Specific examples of predetermined condition include the time, location, and situation when the video was captured. In this case, the feature text generated from the video of children crossing a crosswalk may be: “Capture time: [Month] [Day] [Hour] [Minute], Capture location: [Prefecture] [City] [Town], Situation: A large number of children are crossing the crosswalk.” These predetermined conditions may be changeable as appropriate. In this case, the feature text generation unit 220 may regenerate feature text based on the changed predetermined condition from the video stored in the video data storage unit 210. For example, if a new item is added as a predetermined condition, the feature text generation unit 220 may additionally generate the feature text related to the new item.

The feature text generation unit 220 may generate the feature text using a machine learning model. This model may be one that takes image frames contained in the video data as input and outputs the feature text. This model may be, for example, a large language model (LLM). It may also be a multimodal LLM capable of handling multiple modalities.

The video extraction unit 230 is configured to extract a video corresponding to the feature text input from the server 50 side (specifically, the feature text search unit 530) from among the multiple video data stored in the video data storage unit 210. Furthermore, the video extraction unit 230 is configured to transmit the video data extracted from the video data storage unit 210 to the server 50 side (specifically, the video output unit 540).

The feature text storage unit 510 is configured to store the feature text. Specifically, the feature text storage unit 510 is configured to sequentially acquire and store the feature text generated by the feature text generation unit 220.

The query acquisition unit 520 acquires a search query from the user. The search query is query information for searching the video data stored in the video data storage unit 210 and may be text information including natural language. For example, the search query may include text such as “Time period: daytime, video footage one minute before and after a scene where a pedestrian ignores a traffic signal at an intersection.” The query acquisition unit 520 may acquire text information entered by a vehicle user using a touch panel, etc., as the search query. Alternatively, the query acquisition unit 520 may acquire voice information entered by the vehicle user using a microphone, etc., as the search query. In this case, the query acquisition unit 520 may have a function to convert the acquired voice information into text (i.e., a voice recognition function).

The feature text search unit 530 is configured to search for the feature text stored in the feature text storage unit 510 that match the search query acquired by the query acquisition unit 520. Furthermore, the feature text search unit 530 is configured such that when it finds the feature text matching the search query, it outputs information about that the feature text to the vehicle-mounted device 10 side (specifically, the video extraction unit 230) to request image extraction.

The video output unit 540 is configured to receive a video data extracted by the video extraction unit 230 within the vehicle-mounted device 10 and output it to the user. The video output unit 540 may, for example, output the video data to a display for automatic playback. Furthermore, the video output unit 540 may output multiple video data items. In this case, the video output unit 540 may present a list containing multiple video data items to the user and output the video data item selected by the user from the list. The video data output by the video output unit 540 may be utilized, for example, for analyzing accident causes or automatically generating car life log videos.

### Storage Operation

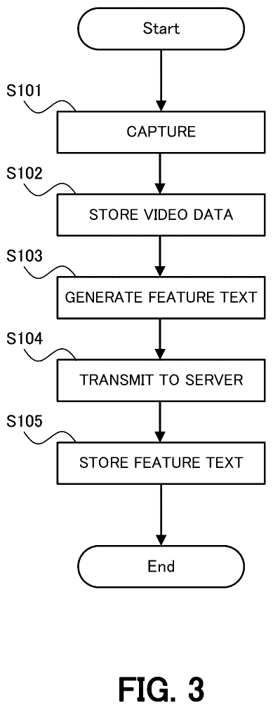

Next, referring to FIG. 3, the flow of the storage operation (specifically, the operation for storing video data and feature text corresponding to the video data) performed by the information processing system 1 according to the example embodiment will be described. FIG. 3 is a flowchart illustrating a flow of a storage operation of the information processing system according to the example embodiment.

As shown in FIG. 3, when the storage operation by the information processing system 1 according to the example embodiment starts, a video is first captured in the vehicle (Step S101), and the video data storage unit 210 storage the captured video data (Step S102).

Next, the feature text generation unit 220 generates the feature text from the video data stored in the video data storage unit 210 (Step S103). Then, the feature text generation unit 220 transmits the generated feature text to the server 50 side (Step S104). The server 50 receives the feature text transmitted by the feature text generation unit 220 and stores it in the feature text storage unit 510 (step S105).

Here, an example was given where the feature text is generated immediately after the video is captured. However, it may also be configured such that feature text is generated after a period of time has elapsed following the video capture (e.g., after a sufficient amount of video has storage in the video data storage unit 210). Furthermore, if predetermined condition related to the feature text are changed, the feature text regeneration may be performed at that time.

### Extraction Operation

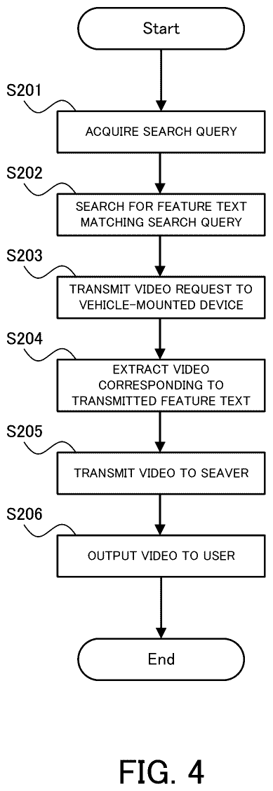

Next, referring to FIG. 4, the flow of the extraction operation performed by the information processing system 1 according to the example embodiment (specifically, the operation for outputting video data matching a search query input by a user from the sored video data) will be described. FIG. 4 is a flowchart illustrating a flow of an extraction operation of the information processing system according to the example embodiment.

As shown in FIG. 4, when the extraction operation by the information processing system 1 according to the example embodiment starts, the query acquisition unit 520 first acquires a search query from the user (Step S201). Then, the feature text search unit 530 searches for the feature text matching the search query acquired by the query acquisition unit 520 among the feature text stored in the feature text storage unit 510 (Step S202).

Next, the feature text search unit 530 transmits information about the feature text matching the search query to the vehicle-mounted device 10 side, requesting video extraction (Step S203). Upon this, the video extraction unit 230 extracts the video corresponding to the requested the feature text from among the multiple video data stored in the video data storage unit 210 (Step S204).

Next, the video extraction unit 230 transmits the video data extracted from the video data storage unit 210 to the video output unit 540 on the server 50 (Step S205). The video output unit 540 then receives the video data extracted by the video extraction unit 230 and outputs it to the user (Step S206).

### Technical Effects

Next, the technical effects obtained by the information processing system 1 according to the example embodiment will be described.

As described in FIGS. 1 to 4, in the information processing system 1 according to the example embodiment, the video data captured by the vehicle is managed on the server 50 using the feature text generated from the video data. This eliminates the need to transmit the actual video data captured by the vehicle to the server 50. Instead, by transmitting only the feature text generated from the video data to the server 50, the video data can be managed appropriately. For example, a user wishing to output desired video data can simply enter the search query on the server 50 side to search the feature text managed there. This causes the video data matching the search query to be extracted on the vehicle side and transmitted to the server 50. This configuration suppresses storage costs on the server 50 side and communication costs between the vehicle-mounted device 10 and the server 50. Furthermore, since video search can be performed using the feature text, it is possible to extract the video matching flexible conditions specified by a text.

This disclosure is not limited to the example embodiment described above, and various modifications can be made without departing from the gist or spirit of the invention as can be understood from the claims and the entire specification. An information processing system incorporating such modifications is also included within the technical scope of the present invention.

### DESCRIPTION OF REFERENCE NUMERALS

1 Information processing system
10 Vehicle-mounted device
50 Server
110 Processing unit
120 Storage unit
130 Communication unit
140 Input unit
150 Output unit
210 Video data storage unit
220 Feature text generation unit
230 Video extraction unit
510 Feature text storage unit
520 Query acquisition unit
530 Feature text search unit
540 Video output unit

1. An information processing system comprising:
a storage configured to store a video captured by a camera mounted on a vehicle within the vehicle;
a generator configured to generate a feature text indicating characteristics of a scene from an image frame contained in the video stored in the storage;
a feature storage provided outside the vehicle and configured to store the feature text;
a query acquirer configured to acquire a search query from a user outside the vehicle to search for the video stored in the storage;
a searcher configured to search for the feature text matching the search query from the feature text stored in the feature storage; and
an outputter configured to extract the video corresponding to the feature text matching the search query from the storage and output the video to the user.

2. The information processing system according to claim 1, wherein
the feature text includes a text corresponding to a predetermined condition set in advance, and
the generator regenerates the feature text when the predetermined condition changes after the feature text is generated, based on the changed predetermined condition.

3. The information processing system according to claim 1, wherein the storage further configured to
assign a priority to the video based on at least one of information relating to the vehicle and information relating to a surrounding situation of the vehicle when the video was captured, and store the video,
delete the video in order of the priority from lower, when deleting the video.

4. The information processing system according to claim 1, wherein
the generator is a large language model that inputs the image frame and outputs the feature text.

5. The information processing system according to claim 2, wherein the storage further configured to
assign a priority to the video based on at least one of information relating to the vehicle and information relating to a surrounding situation of the vehicle when the video was captured, and store the video,
delete the video in order of the priority from lower, when deleting the video.

6. The information processing system according to claim 2, wherein
the generator is a large language model that inputs the image frame and outputs the feature text.
